(19) United States
(12) Patent Application Publication
(10) Pub. No.: US 2006/0265654 A1
(43) Pub. Date: Nov. 23, 2006

(54) Content display-playback system, content display-playback method, recording medium having a content display-playback program recorded thereon, and operation control apparatus

(75) Inventors: Junichi Nakamura, Chiba (JP); Tomoya Narita, Chiba (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Sony Corporation, Shinagawa-ku (JP)

(21) Appl. No.: 11/433,415

(22) Filed: May 15, 2006

(30) Foreign Application Priority Data
May 23, 2005 (JP) 2005-150225

(51) Int. Cl. G06F 3/00

(52) U.S. Cl. 715/704; 715/733; 715/716; 715/719

(57) ABSTRACT

A content display-playback system includes a content providing apparatus connected to a network, a display-playback apparatus connected to the network, and an operation control apparatus for controlling operations on the content providing and display-playback apparatuses. Content is transmitted and received among the content providing, display-playback, and operation control apparatuses. Each of the display-playback and operation control apparatuses displays video of the content and plays back audio of the content. The content is distributed by streaming from the content providing apparatus through the network. The operation control apparatus includes a display-playback unit for displaying video of the distributed content and playing back audio of the distributed content. When display and playback of the content distributed by streaming from the content providing apparatus is switched between the operation control and display-playback apparatuses, the display-playback unit displays an animation indicating content movement.

### CROSS REFERENCES TO RELATED APPLICATIONS

The present invention contains subject matter related to Japanese Patent Application JP 2005-150225 filed in the Japanese Patent Office on May 23, 2005, the entire contents of which are incorporated herein by reference.

### BACKGROUND OF THE INVENTION

1. Field of the Invention

The present invention relates to a content display-playback system and method in which, by using an operation control apparatus to control a content providing apparatus and display-playback apparatus connected to a wired or wireless network, video information is transmitted among the apparatuses, and video is displayed by the display-playback apparatus and the operation control apparatus. The present invention also relates to a recording medium containing a content display-playback program in accordance with the content display-playback method. In addition, the present invention relates to the operation control apparatus that controls operations on the content providing apparatus and the display-playback apparatus through the network.

2. Description of the Related Art

Nowadays, with widespread use of VCRs (video cassette recorders) that record television broadcast programs on video cassettes, a viewing manner has become popular which is based on the concept of a so-called “time shift” in which a viewer views a television broadcast program in a viewer's convenient time different from a broadcast time of the program. In this viewing manner, many television broadcast programs are recorded, and are viewed with a time provided after the recording. In addition, in recent years, a recording medium has changed from a videocassette to a hard disk, thus making it possible to easily store more amounts of video data on the hard disk (storage device) without caring about the storage capacity of the hard disk. A video recorder of the above type which uses a hard disk is hereinafter referred to as a “DVR” unless otherwise indicated.

Recently, a content display-playback system has become known in which AV (audio-visual) content servers (content providing apparatuses), and display-playback apparatuses such as CRTs (cathode-ray tubes), LCDs (liquid crystal displays), and plasma displays, are connected to wired or wireless networks established in homes, business places, areas, and, in addition, in global areas. In this content display-playback system, by connecting at least one DVR as described above, as an AV content server, to the network, for example, a recorded television broadcast program can be viewed at a place remote from the AV content server through the network.

A television receiver of the related art displays, on its display screen, an executable processing selecting menu in response to button operations on a remote controller (such as a remote control unit, operation control apparatus, or remote commander) for the television receiver. A user of the television receiver can perform desired processing such as image quality adjustment and timer setting by using the remote controller to select a desired type of processing and operating the remote controller in accordance with guidance or the like displayed on the display screen.

A receiver or the like, called a name such as “STB (set-top box)” or “IRD (integrated receiver decoder)”, for receiving a satellite broadcast signal, displays data, such as an EPG (electronic program guide), on a display screen of a monitoring unit. In this case, a user of the receiver can change tuning channels by using a remote controller for the receiver to select a desired program to be viewed on the basis of the EPG displayed on the display screen of the monitoring unit.

As described above, in a television receiver and a television broadcast signal receiver, by combining remote control operations and displayed information such as a menu, a guidance, or an EPG, a desired type of processing can be clearly and relatively easily executed.

However, as described above, in order for the television receiver, the STB, or the IRD to perform a desired type of processing, when necessary information, such as a menu and guidance, is displayed on the display screen of the television receiver or the like, and the user operates the remote controller while viewing the displayed information, operations on the remote controller may become complicated.

For example, there may be cases in which page ejection of a menu needs to be performed a plural number of times in order to display, from among a plurality of menus, a menu including a desired type of processing as a selected item, in which a complicated operation needs to be performed on the remote controller in order to move a cursor on the display screen, and in which a determining operation needs to be performed by using the remote controller.

In addition, regarding a monitoring apparatus such as a television receiver, a type of monitoring apparatus increases in number which has portability and reduced size and weight achieved by using an LCD or the like, and which can be used at hand of the user. In this case, the remote controller for the television receiver is unnecessary. In addition, it is cumbersome to use a remote controller for an external input apparatus such as a receiving apparatus for supplying a video signal and an audio signal to the television receiver.

Accordingly, the assignee of the present invention has already proposed a bidirectional communication system having a configuration in which a display apparatus is used to enable viewing video information such as a television program, and listening to audio information, and which enables remote control of a base apparatus for supplying a video signal to the display apparatus and an external input apparatus connected to the base apparatus by using operating display information displayed on a display element of the display apparatus and a contact position detector such as a touch panel. In this configuration, the bidirectional communication system can perform remote control and can establish a home network having good usability without needing complicated operations. According to this bidirectional communication system, by using the operating display information displayed on the display element of the display apparatus and the contact position detector such as a touch panel, the base apparatus for supplying the video signal to the display apparatus and the external input apparatus connected to the base apparatus can be remote-controlled, whereby desired video can easily be selected and can be displayed on the display apparatus.

The assignee of the present invention also disclosed a content display-playback system and video display control apparatus (Japanese Unexamined Patent Application Publication No. 2003-333359) having a configuration in which, by using a bidirectional communication system of the above type, when a base apparatus supplies video signals to a plurality of display apparatuses, an operation of touching a screen with a user's finger enables video transmission and reception among the base apparatus and the display apparatuses. This configuration enables sensory switching differently from a case of the related art in which button operations are performed on a remote controller. In addition, when the switching is performed, images to be switched are displayed. Specifically, by using a user's upward finger gesture to perform an operation on a touch panel on an LCD of a portable display apparatus, a throw function is executed in which video A displayed on the portable display apparatus is displayed on a large display apparatus, which has displayed video B. Also, by a user's downward finger gesture to perform an operation on the touch panel on the LCD of the portable display apparatus, a catch function is executed in which video B displayed on the large display apparatus is displayed on the portable display apparatus, which has displayed video A. At the time of the video switching, the portable display apparatus displays an image indicating switching. As described above, the throw and catch functions described in Japanese Unexamined Patent Application Publication No. 2003-333359 can perform intuitive switching of screens among a plurality of display apparatuses.

### SUMMARY OF THE INVENTION

By using the throw and catch functions, using a switching image, described in Japanese Unexamined Patent Application Publication No. 2003-333359, in the above content display-playback system in which at least one DVR is connected as AV content server to the network, transmission and reception of the video data stored in the AV content server between the portable display apparatus and the large display apparatus can be conceived. In this case, the image indicating switching is originally a still image. Accordingly, there is a need for a screen switching operation which uses an animation and which intuitively informs a user of video switching between display apparatuses.

It is desirable to provide a content display-playback system and a content display-playback method which, for a user, intuitively show video switching between two image display apparatuses in accordance with throw and catch operations, and a recording medium having a content display-playback program recorded thereon, and an operation control apparatus used therewith.

According to an embodiment of the present invention, there is provided a content display-playback system including a content providing apparatus connected to a network, a display-playback apparatus connected to the network, and an operation control apparatus for controlling operations on the content providing apparatus and the display-playback apparatus, wherein content is transmitted and received among the content providing apparatus, the display-playback apparatus, and the operation control apparatus, and each of the display-playback apparatus and the operation control apparatus displays video of the content and plays back audio of the content, the content is distributed by streaming from the content providing apparatus through the network, the operation control apparatus includes an operation-control-apparatus display-playback unit for displaying video of the distributed content and playing back audio of the distributed content, and, when display and playback of the content distributed by streaming from the content providing apparatus is switched between the operation control apparatus and the display-playback apparatus connected to the network, the operation-control-apparatus display-playback unit displays an animation indicating content movement.

According to another embodiment of the present invention, there is provided a content display-playback method for controlling operations on a content providing apparatus and display-playback apparatus connected to a network by using an operation control apparatus, transmitting and receiving content among the operation control apparatus, the content providing apparatus, and the display-playback apparatus, and displaying video of the content and playing back audio of the content by each of the display-playback apparatus and the operation control apparatus. The content display-playback method includes the steps of, between the display-playback apparatus connected to the network and the operation control apparatus, switching display and playback of content distributed by streaming from the content providing apparatus, and, when the display and playback of the distributed content is switched, displaying an animation indicating content movement by a display-playback unit included in the operation control apparatus.

Preferably, the content display-playback method further includes the step of, when the display and playback of the distributed content is switched, creating an animation by storing, in a video memory, the video displayed on one of the display-playback unit and the display-playback apparatus connected to the network. In the displaying step, the created animation is used to display the animation indicating the content movement.

According to another embodiment of the present invention, there is provided a recording medium having a content display-playback program recorded thereon for controlling operations on a content providing apparatus and display-playback apparatus connected to a network by using an operation control apparatus, transmitting and receiving content among the operation control apparatus, the content providing apparatus, and the display-playback apparatus, and displaying video of the content and playing back audio of the content by each of the display-playback apparatus and the operation control apparatus. The content display-playback program includes the steps of, between the display-playback apparatus connected to the network and the operation control apparatus, switching display and playback of content distributed by streaming from the content providing apparatus, and, when the display and playback of the distributed content is switched, displaying an animation indicating content movement by a display-playback unit included in the operation control apparatus.

According to another embodiment of the present invention, there is provided an operation control apparatus for controlling operations on a content providing apparatus and display-playback apparatus connected to a network, transmitting and receiving content among the operation control apparatus, the content providing apparatus, and the display-playback apparatus, and displaying and playing back the content by each of the operation control apparatus and the display-playback apparatus. The operation control apparatus includes an input operation receiving unit for receiving an operation input from a user, a content-transmission/reception-signal generating unit for generating an operation control signal for transmitting and receiving the content among the operation control apparatus, the content providing apparatus, and the display-playback apparatus in response to the operation input received by the input operation receiving unit, and a display-playback unit for displaying and playing back desired content in response to a selecting operation control signal and display-playback operation control signal generated by the content-transmission/reception-signal generating unit on the basis of a selecting operation on the desired content and an operation for displaying and playing back the desired content which are received by the input operation receiving unit. When display and playback of content distributed by streaming from the content providing apparatus is switched between the operation control apparatus and the display-playback apparatus connected to the network, the display-playback unit displays an animation indicating content movement.

The operation control apparatus may further include an animation creating unit for creating an animation by storing, in a video memory, video displayed by one of the display-playback unit and the display-playback apparatus connected to the network when the display and playback of the distributed content is switched.

In the operation control apparatus, when the input operation receiving unit performs a first switching operation for allowing the display-playback apparatus connected to the network to display and play back the desired content displayed and played back by the display-playback unit, the animation indicating the content movement may be displayed on the display-playback unit while the animation creating unit uses the video memory to reduce a size of the video displayed when the display and playback of the distributed content is switched, and upwardly changes a display position of the video.

In the operation control apparatus, when the input operation receiving unit performs a second switching operation for allowing the display-playback unit to display and play back the content displayed and played back by the display-playback apparatus connected to the network, the animation indicating the content movement may be displayed on the display-playback unit while the animation creating unit uses the video memory to gradually enlarge the video displayed when the display and playback of the distributed content is switched, and changing a display position of the video from upwardly to centrally on the display-playback unit.

According to a content display-playback system and content display-playback method according to embodiments of the present invention, when display and playback of content distributed by streaming from a content providing apparatus is switched between an operation control apparatus and a display-playback apparatus connected to a network, switching of video can intuitively be displayed for a user.

According to a recording medium according to an embodiment of the present invention, a content display-playback program can widely be provided which can intuitively display switching of video for a user when display and playback of content distributed by streaming from a content providing apparatus is switched between an operation control apparatus and a display-playback apparatus connected to a network.

According to an operation control apparatus according to an embodiment of the present invention, when display and playback of content distributed by streaming from a content providing apparatus is switched between the operation control apparatus and a display-playback apparatus connected to a network, switching of video can intuitively be displayed for a user.

### BRIEF DESCRIPTION OF THE DRAWINGS

FIG. 1 is a block diagram showing a content display-playback system;

FIG. 2 is a block diagram showing a content providing apparatus;

FIG. 3 is a block diagram showing the hardware of the content providing apparatus;

FIG. 4 is a functional block diagram showing a display-playback apparatus;

FIG. 5 is a block diagram showing the hardware of the display-playback apparatus;

FIG. 6 is a functional block diagram showing an operation control apparatus;

FIG. 7 is a block diagram showing the hardware of the operation control apparatus;

FIG. 8 is an illustration of software of the operation control apparatus;

FIG. 9 is an illustration of a display-playback process of the operation control apparatus;

FIG. 10 is an illustration of a throw operation by the operation control apparatus;

FIG. 11 is an illustration of a catch operation by the operation control apparatus;

FIG. 12 is a flowchart showing a process in which the operation control apparatus performs the throw operation while receiving moving image content distributed by streaming from a content providing apparatus; and

FIG. 13 is an illustration showing an example of a switching animation displayed on an LCD of the operation control apparatus when the throw operation is performed.

### DESCRIPTION OF THE PREFERRED EMBODIMENTS

Embodiments of the present invention are described below with reference to the accompanying drawings.

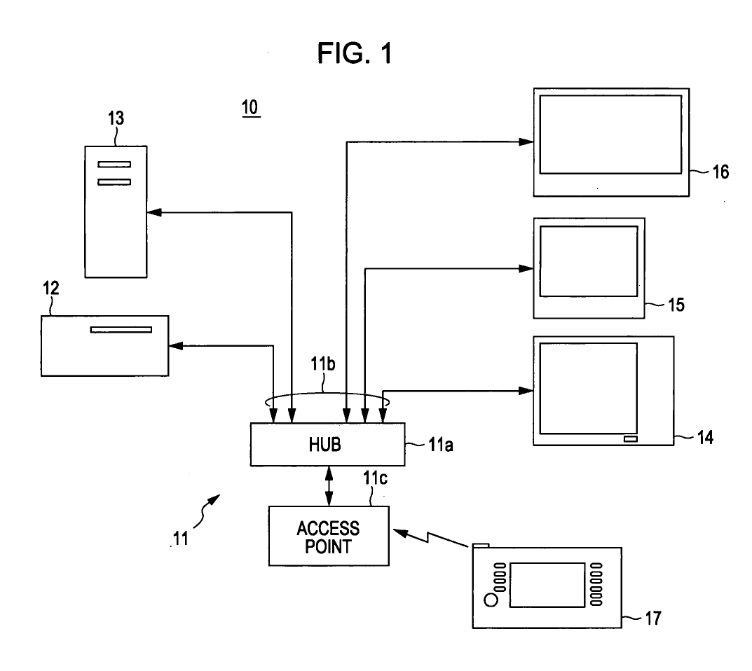

FIG. 1 is a block diagram showing the configuration of a content display-playback system 10 to which an embodiment of the present invention is applied. In the content display-playback system 10, two content providing apparatuses 12 and 13, whose specific examples are AV content servers such as DVRs, and three display-playback apparatuses 14, 15, and 16 which have display elements such as CRTs, LCDs, PDPs (plasma display panels) for displaying video and which play back audio associated with the video are connected to a home network 11 formed by combining a wireless network and a wired network. In addition, an operation control apparatus 17 for controlling operations on each content providing apparatus and each display-playback apparatus is connected to the home network 11.

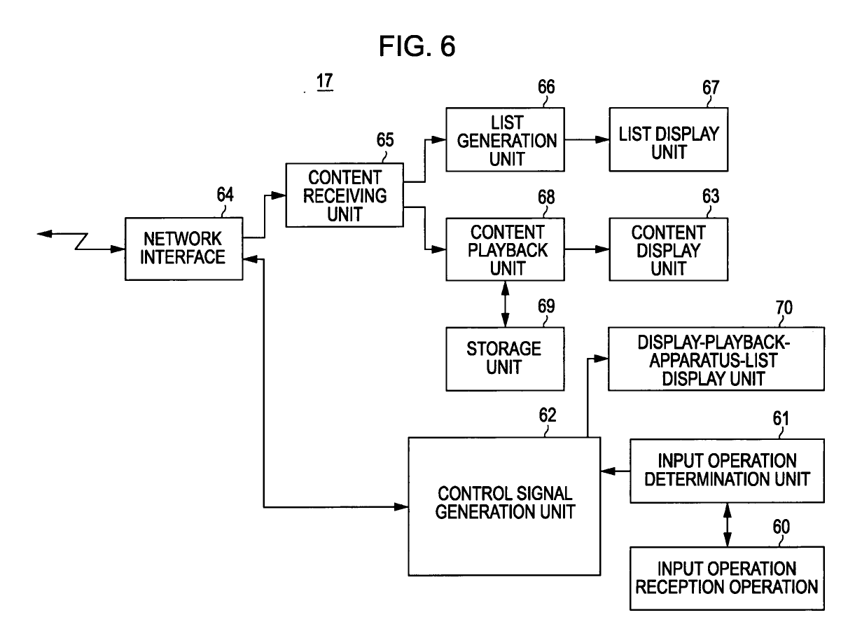

In this content display-playback system 10, the operation control apparatus 17 includes a content display unit 63 (FIG. 6), serving as an in-apparatus display-playback unit, for displaying video of content distributed by streaming from the content providing apparatus 12 or 13 through the home network 11 and which plays back audio of the content. In the case of switching content display and playback for the streaming distribution from the content providing apparatus 12 among the display-playback apparatuses 14 to 16 connected to the home network 11, the content display unit 63 displays an animation indicating movement of the content.

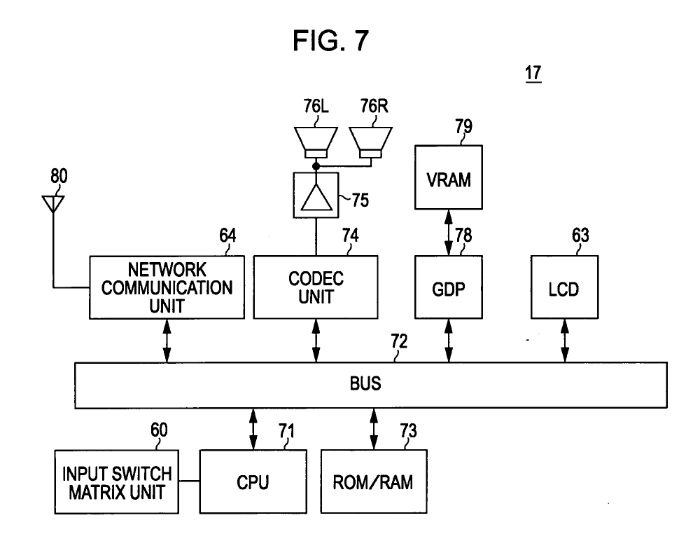

Accordingly, the operation control apparatus 17 includes an animation creator (the CPU 71, GDP (graphics display processor) 78, and VRAM (video random access memory) 79 shown in FIG. 7) in which, when switching content display and playback, images displayed on the content display unit 63 or the network-connected display-playback apparatus 14 are stored in a video memory 79 (FIG. 7) for creating an animation.

The operation control apparatus 17 also includes an input operation reception unit 60 for receiving an operation input from a user, and a control signal generation unit 62, serving as, for generating an operation control signal for transmitting and receiving the content among the apparatuses in response to the operation input received by the input operation reception unit 60. The content display unit 63 displays and plays back desired content in response to a selecting operation control signal and display-playback operation control signal generated by the control signal generation unit 62 on the basis of a desired content selection operation and an operation for displaying and playing back the content which are received by the input operation reception unit 60.

When the input operation reception unit 60 performs a first switching operation (throw operation) for allowing the display-playback apparatus 14, 15, or 16 connected to the home network 11 to display and play back the desired content displayed and played back by the content display unit 63, the operation control apparatus 17 displays an animation indicating content movement while using a video memory (the VRAM 79) in the animation creator to reduce the size of an image displayed at the time of the switching operation by the content display unit 63 and upwardly changing the display position of the displayed image.

When the input operation reception unit 60 performs a second switching operation (catch operation) for allowing the content display unit 63 to display and play back content displayed and played back by the display-playback apparatus 14, 15, or 16 connected to the home network 11, the operation control apparatus 17 displays an animation indicating movement of the content on the content display unit 63 while using the VRAM 79 in the animation creator to gradually enlarge, from a reduced state, an image displayed at the time of the switching operation by the display-playback apparatus 14, 15, or 16 connected to the home network 11, and changing the display position of the image from upward to the center of the content display unit 63.

The home network 11 is an in-home digital network. The home network 11 connects the two content providing apparatuses 12 and 13, and the three display-playback apparatuses 14 to 16, as described above, by a wire cable 11b based on, for example, IEEE 1394, through a hub 11a. In addition, in the home network 11, an access point 11c is linked to the hub 11a, and the operation control apparatus 17 is wirelessly linked by using a predetermined protocol such as the IEEE 802.11 protocol or an extended protocol thereof. Accordingly, the operation control apparatus 17 is connected to the content providing apparatuses 12 and 13, and display-playback apparatuses 14 to 16 which are connected to the home network 11, and can control operations of them.

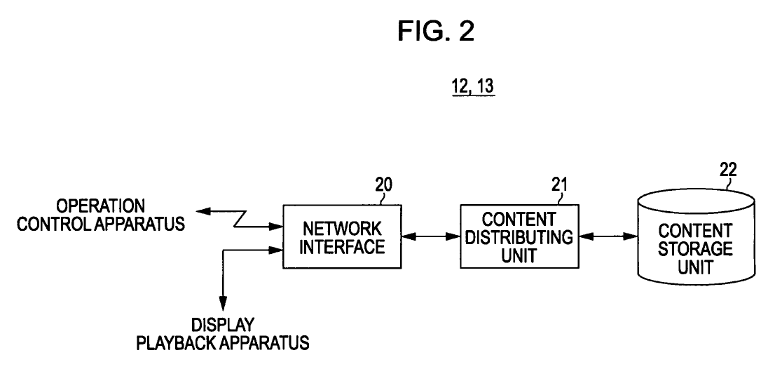

FIG. 2 is a functional block diagram showing the content providing apparatus 12. This also applies to the content providing apparatus 13. The content providing apparatus 12 is an AV content server such as the above DVR. The content providing apparatus 12 includes a network interface 20, a content distributing unit 21, and a content storage unit 22.

In the content providing apparatus 12 in the content display-playback system 10, video and audio content (hereinafter referred to as “content”), received in a home through BS (broadcasting satellite) digital broadcasting, CS (communication satellite) digital broadcasting, analog terrestrial broadcasting, and the Internet, is stored as streaming data in the content storage unit 22, which is formed by a mass storage medium such as a hard disk. In the content providing apparatus 12, the content distributing unit 21 can read and play back the streaming data stored in the content storage unit 22 in response to a distribution request transmitted from the operation control apparatus 17 through the network interface 20, and can distribute the played-back data by streaming through the network interface 20 to one display-playback apparatus or the operation control apparatus 17, which sends the request.

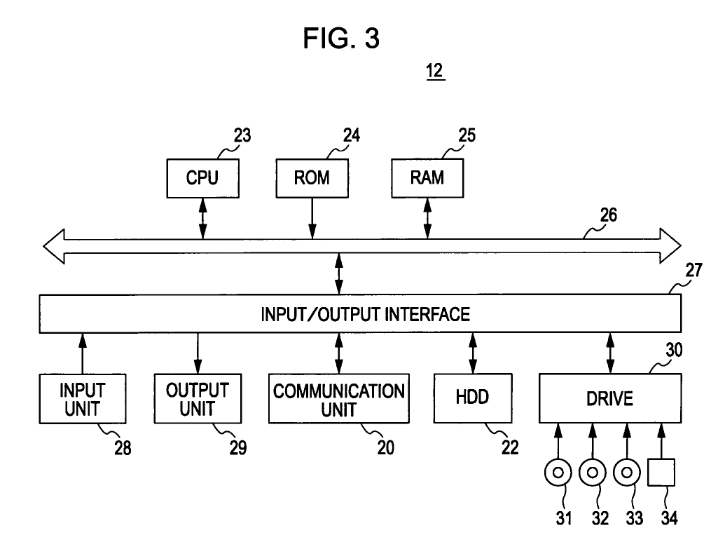

FIG. 3 is a block diagram showing an example of the hardware configuration of the content providing apparatus 12. A CPU 23 executes various types of processing in accordance with a server program stored in a ROM (read-only memory) 24 or a server program loaded from an HDD (hard disk drive) 22 to a RAM 25. The RAM 25 also stores data, etc., which are necessary for the CPU 23 to execute the various types of processing.

The CPU 23, the ROM 24, and the RAM 25 are connected to one another by a bus 26. The bus 26 connects to an input/output interface 27.

The input/output interface 27 connects an input unit 28 including a button, a switch, a keyboard, and a mouse, an output unit 29 including a display such as a CRT or LCD, and a speaker, a communication unit 20 serving as the network interface 20 and including a modem and a terminal adapter, and the HDD 22 serving as the content storage unit 22.

The network interface 20 performs communication through the home network 11. In the content display-playback system 10, the communication units 20 of the content providing apparatuses 12 and 13 are connected to the access point 11c for a wireless LAN (local area network) by wires 11b through the hub 11a. The content providing apparatuses 12 and 13 are also connected to the three display-playback apparatuses 14 to 16 by wires 11b through the hub 11a. Thus, the content providing apparatuses 12 and 13 are linked to the operation control apparatus 17 on a wireless communication path in the home network 11 through the network interface 20, and are connected to the display-playback apparatuses 14 to 16 on wired communication paths formed by the wires 11b. The access point 11c for the wireless LAN and the operation control apparatus 17 (described later) perform wireless communication in accordance with a predetermined protocol such as the IEEE 802.11 protocol or an extended protocol thereof.

The content storage unit 22 stores not only a server program but also media data for streaming distribution.

A drive 30 is connected to the input/output interface 27, if necessary, and a magnetic disk 31, an optical disk 32, a magneto-optical disc 33, a semiconductor memory 34, or the like, is loaded into the drive 30, if necessary. A computer program (such as a server program) read from such a medium is installed in the HDD 22, if necessary.

In a relationship with the functional block diagram shown in FIG. 2, the blocks shown FIG. 3 are as follows: the network interface 20 functions as the network interface 20, and the HDD 22 functions as the content storage unit 22. The media 31 to 34, etc., which are connected to the CPU 23, the ROM 24, the RAM 25, and the drive 30, each function as the content distributing unit 21.

Thus, on the basis of the hardware configuration, an operation of the content providing apparatus 12 is described below. The content providing apparatus 12 is a computer and its CPU 23 executes distributing streaming data on the basis of the server program. For example, the content providing apparatus 12 stores data of various media in the HDD 22. When being requested to distribute, by streaming, data of a predetermined medium through the home network 11, the content providing apparatus 12 reads corresponding content data, generates predetermined packets for performing streaming distribution, and distributes the packets through the home network 11.

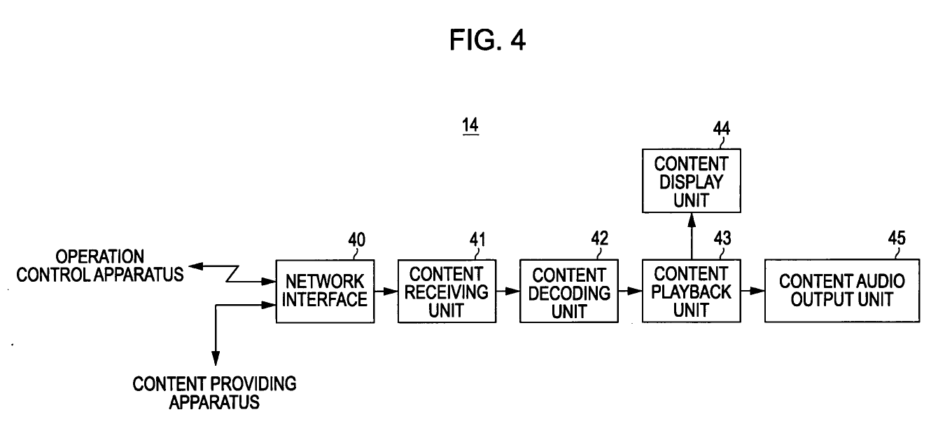

FIG. 4 is a functional block diagram showing each of the display-playback apparatuses 14 to 16. For example, the display-playback apparatus 14 has a streaming playback function capable of receiving streaming data distributed by streaming from the content providing apparatus 12 or 13 and displaying video by playing back the received data on an LCD or CRT, and outputs, from a speaker, audio by playing back audio data associated with the video. The display-playback apparatus 14 includes a network interface 40 for establishing connection to the home network 11, a content receiving unit 41 for receiving streaming data (content data) through the network interface 40, a content decoding unit 42 for decoding the content data, a content playback unit 43 for playing back the content data decoded by the content decoding unit 42, a content display unit 44 for displaying video of the played-back content, and a content audio output unit 45 for outputting audio of the played-back content.

The display-playback apparatus 14 operates as a streaming playback functional unit by using the above functional units in the following manner. The network interface 40 is used to establish connection to the home network 11, and the network interface 40 is used to receive the streaming data (content data). The content decoding unit 42 is used to decode the content data, and the content playback unit 43 is used to play back the content data played back by the content decoding unit 42. The content display unit 44 is used to display video of the content played back by the content display unit 44 and the content audio output unit 45 is used to output audio associated with the video.

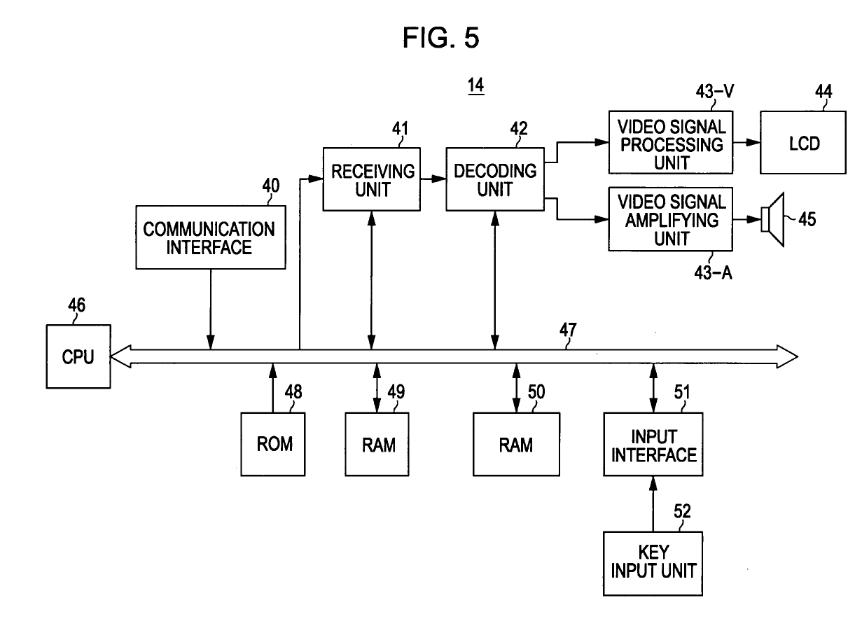

FIG. 5 is a block diagram showing an example of the hardware configuration of each of the display-playback apparatuses 14 to 16. The display-playback apparatus 14 includes, for example, a communication interface 40, a receiving unit 41, a decoding unit 42, a video signal processing unit 43-V, an audio signal amplifying unit 43-A, and a speaker 45. The functional units of the display-playback apparatus 14 can be controlled by a controller mainly having a CPU 46. The controller is a microcomputer including the CPU 46, a ROM 48, a RAM 49, and an EEPROM 50 which are connected to one another by a CPU bus 47. The CPU 46 is connected to a key input unit 52 by an input interface 51, and receives an operation signal representing an operation such as sound volume adjustment, image quality adjustment, or power-on/off.

The ROM 48 stores various types of processing programs which are executed by the display-playback apparatus 14, or the like, and data necessary for processing. The RAM 49 is used mainly as a work area for various types of processing in a manner such as temporarily storing data obtained by various types of processing.

The EEPROM 50 is a so-called “nonvolatile memory” in which, even if its power is turned off, stored information is not lost, and, for example, various types of parameters, etc., can be stored.

The communication interface 40 performs communication through the home network 11. In the content display-playback system 10, the communication interface 40 of the display-playback apparatus 14 is connected to the access point 11c for the wireless LAN by the wire 11b through the hub 11a. The network interface 40 is connected to the content providing apparatuses 12 and 13 by the wires 11b through the hub 11a. Hence, the display-playback apparatuses 14 to 16 are linked to the operation control apparatus 17 on wireless communication paths in the home network 11 through their communication interfaces 40, and are connected to the content providing apparatuses 12 and 13 on wired communication paths formed by the wires 11b.

The content receiving unit 41 performs processing, such as decoding, on a supplied signal, and supplies the decoded signal to the decoding unit 42 (decompressing unit). The content providing apparatuses 12 and 13 transmit data obtained by compressing information signals such as display data, such as text data and video data of a terrestrial broadcast program, audio data, or video and audio signals of a satellite broadcast program.

Accordingly, after the decoding unit 42 of the display-playback apparatus 14 receives the decoded signal from the content receiving unit 41 which represents the compressed data, the decoding unit 42 separates the received signal into a video signal and an audio signal, and restores the original signals prior to data compression by decompressing the separated signals.

The decoding unit 42 generates an analog video signal and an analog audio signal by performing digital-to-analog (A/D) conversion on the restored video and audio signals. The decoding unit 42 supplies the analog audio signal to the video signal processing unit 43-V and supplies the analog audio signal to the audio signal amplifying unit 43-A.

The video signal processing unit 43-V generates a display signal on the basis of the video signal supplied from the decoding unit 42, and supplies the display signal to the content display unit 44 as an LCD. This allows a display screen of the LCD 44 to display video corresponding to the video signal transmitted from the content providing apparatus 12 or 13.

The audio signal amplifying unit 43-A amplifies the supplied audio signal to a predetermined level and supplies the amplified audio signal to the content audio output unit 45 as a speaker. This allows the speaker 45 to emit audio that is associated with the video signal transmitted from the content providing apparatus 12 or 13.

As described above, after receiving and playing back video and audio signals, such as a television broadcast program, transmitted from the content providing apparatus 12 or 13, each of the display-playback apparatuses 14 to 16 can output the played-back video and audio signals, whereby the video and audio signals can be provided to the user.

FIG. 6 is a functional block diagram of the operation control apparatus 17. The operation control apparatus 17 is a remote controller for controlling operations on the content providing apparatuses 12 and 13, and display-playback apparatuses 14 to 16 which are connected to the home network 11. The operation control apparatus 17 has a display device such as an LCD, and can receive and play back AV content distributed by streaming from the content providing apparatuses 12 and 13. In other words, the operation control apparatus 17 has both an AV content streaming playback function and a function of controlling the content providing apparatuses 12 and 13, and display-playback apparatuses 14 to 16 which are connected to the home network 11.

Specifically, the operation control apparatus 17 controls transmission and reception of video information between the apparatuses including the operation control apparatus 17 itself, and controls display of video and playback of audio in the display-playback apparatuses 14 to 16 and the operation control apparatus 17 itself. Accordingly, the operation control apparatus 17 includes an input operation reception unit 60 for receiving an operation input from the user, a control signal generation unit 62 whose one function is a video-information-transmission/reception-signal generating function for generating an operation signal for transmitting video information among the apparatuses in response to the operation input, and a content display unit 63 for displaying video information played back by streaming in response to the operation signal generated by the control signal generation unit 62. In addition, the operation control apparatus 17 has an audio playback function for playing back audio information, and includes a built-in speaker and headphone terminal through which reproduced sounds can be heard. The operation control apparatus 17 in this embodiment can also be used as a display-playback apparatus that displays and plays back content.

The operation control apparatus 17 also includes a network interface 64 for performing wireless communication with the access point 11c for the wireless LAN on the home network 11 in accordance with a predetermined protocol such as the IEEE 802.11 protocol or an extended protocol thereof. The operation control apparatus 17 also includes a content receiving unit 65 which receives content information stored in the content providing apparatuses 12 and 13 and which performs processing, such as demodulation, on the received information.

The operation control apparatus 17 also includes a list generation unit 66 for generating a content list from the content information received and demodulated by the content receiving unit 65, and a list display unit 67 for displaying the content list generated by the list generation unit 66. The operation control apparatus 17 also includes a content playback unit 68 for playing back content data obtained such that the content receiving unit 65 receives and demodulates the content information, and a storage unit 69 for storing the content data to be played back by the content playback unit 68. The content data played back by the content playback unit 68 is displayed as video by the content display unit 63.

The operation control apparatus 17 includes an input operation determination unit 61 between the input operation reception unit 60 and the control signal generation unit 62. The input operation determination unit 61 determines a type of an input operation received by the input operation reception unit 60.

The control signal generation unit 62 generates various control signals on the basis of determination results by the input operation determination unit 61 for key input operations such as pressing, rotating, pushing-up, and pushing-down of an operation key or the like of the input operation reception unit 60 by the user. Specific examples of the generated control signals include a throw operation signal for allowing a desired a display-playback apparatus to play back, by streaming, content data stored in a desired content providing apparatus. The specific examples include a catch operation signal for allowing the content display unit 63 of the operation control apparatus 17 to display content data being displayed on a display-playback apparatus. The specific examples include a reproducing operation signal for reproducing content data in the storage unit 69 when the catch operation is performed.

In addition, the control signal generation unit 62 generates a content provision selecting signal for selecting the content providing apparatus 12 or 13 on the basis of a user's input operation. The control signal generation unit 62 also generates a content selecting signal for selecting desired content. The content selecting signal is generated by the list generation unit 66 from the content information received by the content receiving unit 65 and is generated in response to an operation of the user, who views the content list displayed on the list display unit 67. The control signal generation unit 62 also generates a display-playback-apparatus selecting signal for selecting one of the display-playback apparatuses 14 to 16. The display-playback-apparatus selecting signal is generated in response to an operation of a user, who views a display-playback-apparatus list displayed on the display-playback-unit/list-display unit 70.

Obviously, the control signal generation unit 62 generates, not only playback operation signals for playing back, stopping, and pausing content on the content display unit 63 of the operation control apparatus 17 itself, but also operation signals such as starting, stopping, and pausing playback of the content in each of the display-playback apparatuses 14 to 16 in which displaying is selected.

FIG. 7 is a block diagram showing an example of the hardware configuration of the operation control apparatus 17. In the operation control apparatus 17, a CPU 71 is connected to a network interface 64, a codec processing unit 74, and a GDP 78 through a bus 72. Also, the CPU 71 is connected to a ROM/RAM 73, an LCD 63, and the storage unit 69. The CPU 71 connects to an input switch matrix unit as the input switch matrix unit 60. The GDP 78 connects to a VRAM 79 for creating an animation.

The network communication unit 64 performs wireless communication with the access point 11c for the wireless LAN through an antenna 80 in accordance with a predetermined protocol such as the IEEE 802.11 protocol or an extended protocol thereof.

In wireless communication by the network communication unit 64, the CPU 71 functions as the control signal generation unit 62 in response to a user's input operation using the input operation unit (input switch matrix unit) 60, whereby each generated control signal can be transmitted to the content providing apparatuses 12 and 13, or display-playback apparatuses 14 to 16 which are connected to the home network 11 through the access point 11c. The CPU 71 can also receive response signals from the apparatuses.

The ROM 73 stores a content display-playback program according to an embodiment of the present invention which is to be executed by the operation control apparatus 17, various types of processing programs, and data necessary for processing. The RAM 73 is used mainly as a work area for various types of processing in a manner such as temporarily storing data obtained by various types of processing.

Obviously, the operation control apparatus 17 may include an EEPROM as a nonvolatile memory. By including this EEPROM, in the operation control apparatus 17, stored information is not lost even if its power is turned off, for example, various types of parameters, etc., can be stored.

The storage unit 69 is a memory that stores content data distributed by streaming from the content providing apparatus 12 or 13, for example, at the time of the catch function. The storage unit 69 may be a semiconductor memory or HDD.

The codec processing unit 74 decodes the video data and audio data that are separated under the control of the CPU 71 after being distributed by streaming through the control signal generation unit 62. Video signal processing is implemented on the decoded video information by the GDP 78 and is displayed on the LCD 63. In addition, the audio information is amplified by an amplifier 75, and the amplified audio information is sent and emitted from two-channel stereo speakers 76L and 76R.

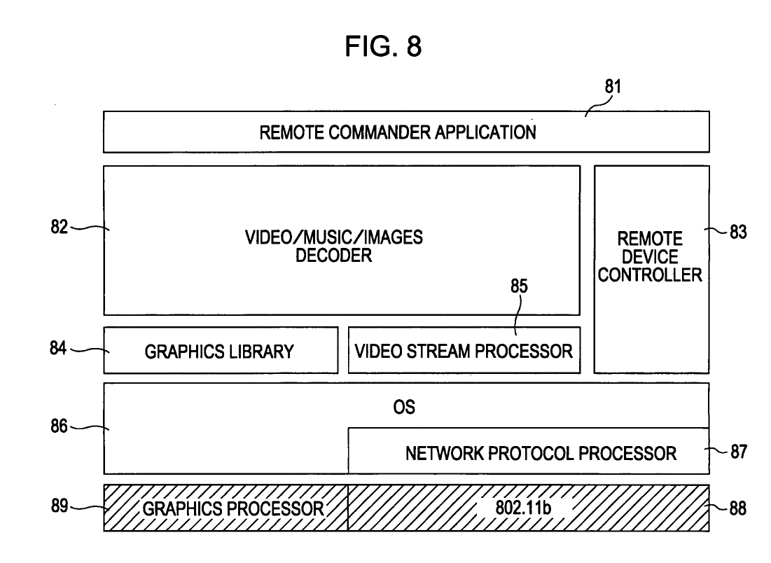

FIG. 8 is a block diagram of software that is executed by the CPU 71 of the operation control apparatus 17 in the above hardware configuration. This software configuration includes a remote commander application 81 for generating remote control signals and controlling the content providing apparatuses 12 and 13, and the display-playback apparatuses 14 to 16. In addition, a video/music/image decoder 82, a remote device controller 83, a graphics library 84, and a video stream processor 85 are executed on the basis of an OS (operating system) 86. A network protocol processor 87 executes an IEEE 802.11b wireless protocol 88. A graphics processor 89 is controlled by the GDP 78 to operate.

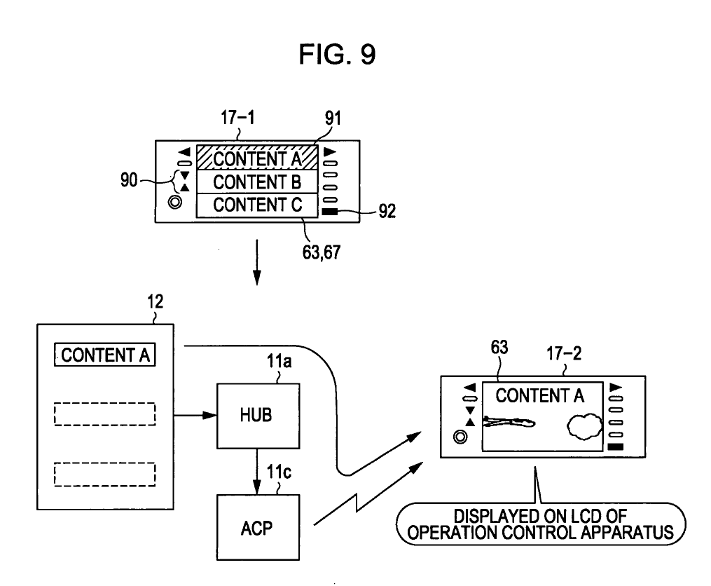

Displaying on the operation control apparatus 17, displaying on each display-playback apparatus in response to the throw operation, and displaying on the operation control apparatus 17 in response to the catch operation are shown in FIGS. 9, 10, and 11.

At first, on the LCD 63 on a display panel provided on the operation control apparatus 17 shown in FIG. 9, pieces of content are displayed in list form (17-1) from content information stored in the content providing apparatus 12. By selecting content in such a manner as using cursor moving buttons 90 to position a cursor 91 on a desired content name (hatched portion on the list), and pressing a determination button 92, selected content A is displayed (17-2) on the LCD 63 of the operation control apparatus 17. At this time, if there is history information representing playback in the past of content A to a halfway point, content A can be played back from the halfway point.

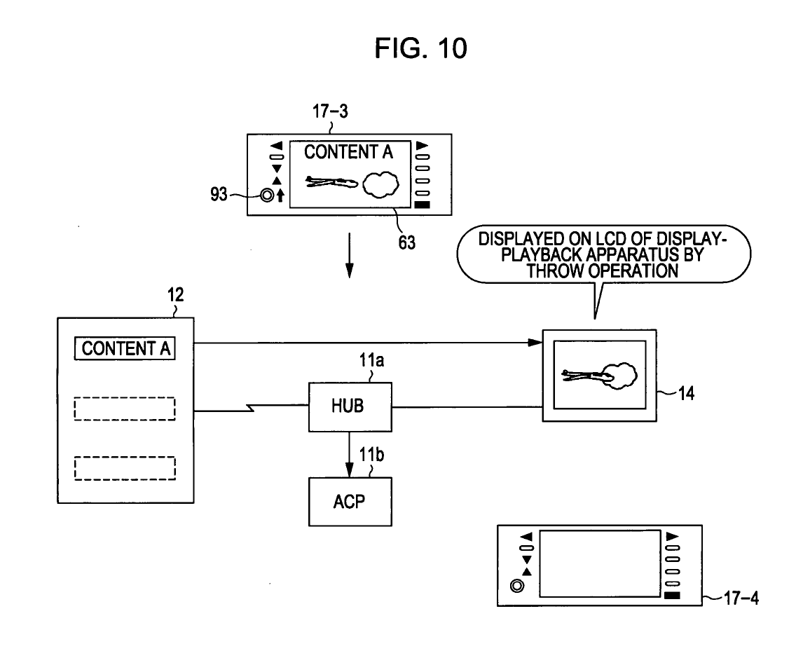

Next, as shown in FIG. 10, the case of performing control so that selected content A is played back by the display-playback apparatus 14 is described below. This operation control apparatus 17 is provided with a joystick 93 on the operation panel, and operations on the joystick 93 are assigned to types of content switching. When content selected by the operation control apparatus 17 is displayed by the display-playback apparatus 14 after switching the operation control apparatus 17 to the display-playback apparatus 14, by moving the joystick 93 upwardly (as indicated by the upward black arrow), the throw operation is performed (17-3). The throw operation allows the display-playback apparatus 14 to play back content A by streaming. At this time, content A displayed on the LCD 63 of the operation control apparatus 17 disappears. Obviously, content A may remain displayed on the LCD 63 without disappearing. Although the throw operation is performed from a state in which content A is displayed on the LCD 63 of the operation control apparatus 17, an icon of content A is selected by the operation control apparatus 17, and the throw operation is immediately performed.

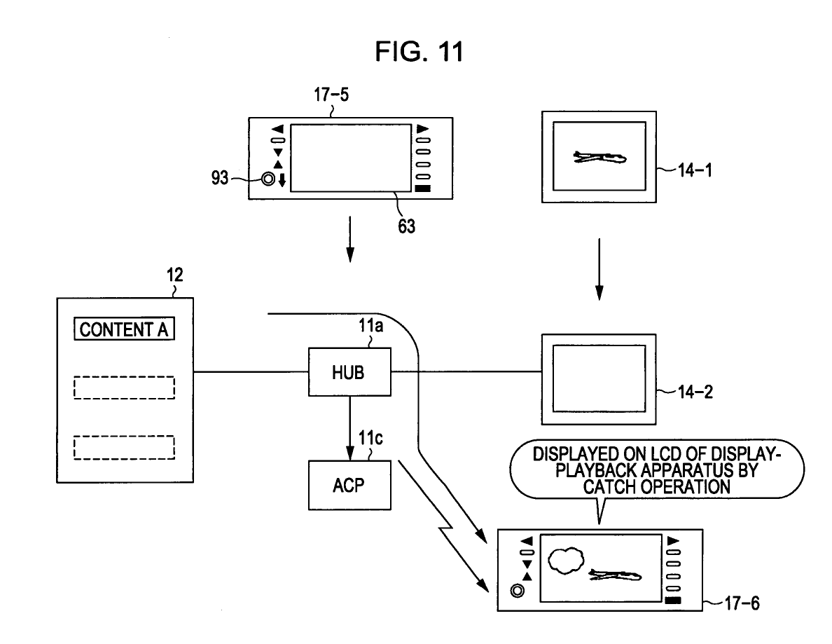

Next, as shown in FIG. 11, the case of performing control so that selected content A is played back again by the operation control apparatus 17 is described below. As described above, in the operation control apparatus 17, the operations on the joystick 93 are assigned to the types of content switching. When the display-playback apparatus 14 (14-1) is switched to the operation control apparatus 17 for displaying content A selected by the operation control apparatus 17, by moving the joystick 93 downwardly (indicated by the downward black arrow), the catch operation is performed (17-5). This catch operation switches the display-playback apparatus 14 to the operation control apparatus 17 displaying content A, and content A is played back by streaming by the operation control apparatus 17 (17-6). At this time, content A displayed on the LCD of the display-playback apparatus 14 disappears (14-2). Obviously, content A displayed on the LCD of the display-playback apparatus 14 may remain displayed without disappearing.

The content display-playback system 10 displays video data stored in each content providing apparatus in response to the throw operation and catch operation using the operation control apparatus 17 while transmitting and receiving the video data among the display-playback apparatuses 14 to 16 or between the operation control apparatus 17. In addition, in the content display-playback system 10, an operation of reproduction into the storage unit 69 is intuitively performed. In an example of the related art, using a throw/catch function achieves transmission and reception of video data existing in the AV content server among the portable display apparatuses and large display apparatuses. However, an intuitive operation is difficult because displaying of the video data which includes an operation of reproducing the video data into a different storage device or storage medium is different processing.

Here, processing that performs the throw operation while video content is received by streaming from the content providing apparatus 12 is described below. In order to intuitively inform the user of the throw operation, the processing uses an animation indicating content movement. A process of the CPU 71 in the operation control apparatus 17 is described below.

This process is based on a content display-playback program in accordance with a content display-playback method according to an embodiment of the present invention. The content display-playback method performs controlling operations on the content providing apparatuses 12 and 13, and display-playback apparatuses 14 to 16 which are connected to the home network 11, transmitting and receiving content between the apparatuses including the operation control apparatus 17, and displaying video of the content and playing back audio of the content in the display-playback apparatuses 14 to 16, and the operation control apparatus 17. In this content display-playback method, the operation control apparatus 17 includes the content display unit 63 that displays and plays back video and audio of content that is distributed by streaming from the content providing apparatuses 12 and 13 through the home network 11. When, among the display-playback apparatuses 14 to 16, display and playback of content is switched for streaming distribution from the content providing apparatuses 12 and 13, this content display-playback method includes an animation creating step in which, when the display and playback of the content is switched, video displayed on the content display unit 63 or the network-connected display-playback apparatuses 14 to 16 is stored in the VRAM 79, and an animation is created.

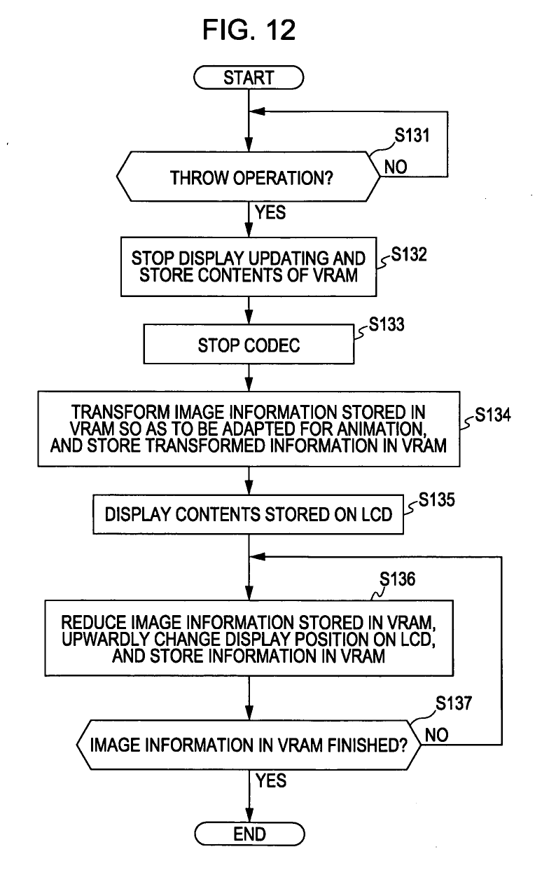

FIG. 12 is a flowchart showing a process that is performed by the operation control apparatus 17 having the configuration shown in FIG. 7 in accordance with a program corresponding to the above content display-playback method. In step S131, the CPU 71 determines whether or not the throw operation has been performed by upwardly moving the joystick 93 in the input switch matrix unit 60. If the CPU 71 has determined that the throw operation has been performed, the process proceeds to step S132, and the CPU 71 stops display updating by the GDP 78 and stores the contents of the VRAM 79.

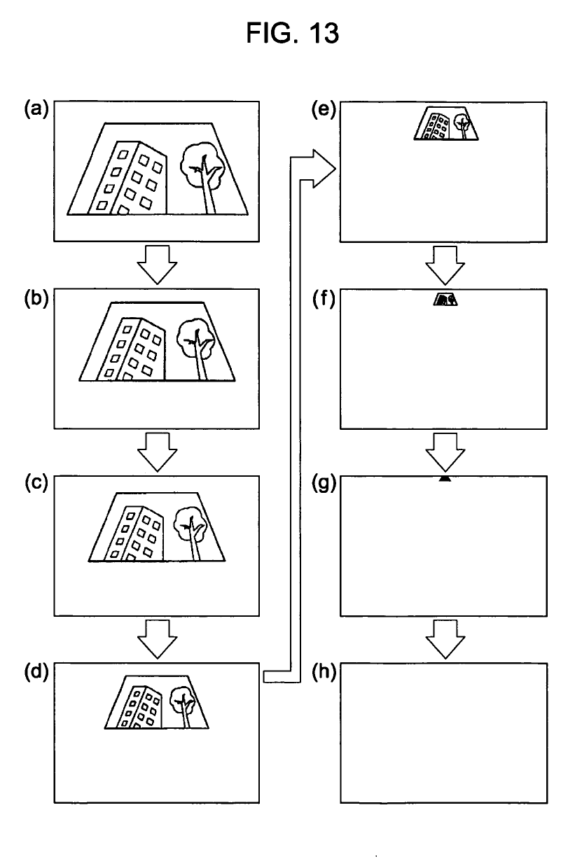

In step S133, the CPU 71 stops codec processing. In step S134, the CPU 71 controls the GDP 78 to transform image information stored in the VRAM 79 to a shape adapted for an animation, for example, a trapezoid as shown in FIG. 13, and stores the shape in the VRAM 79.

In step S135, the CPU 71 controls the contents of the VRAM 79 to be displayed on the LCD 63. After that, in step S136, the CPU 71 controls the GDP 78 to reduce the size of the image information stored in the VRAM 79 as shown in portions (a) to (h) of FIG. 13, and stores the reduced image information in the VRAM 79 after changing (increasing the Y-coordinate of) its display position in an upper direction of the LCD 63. After that, step S136 is repeatedly performed until it is determined in step S137 that image information finishes. In the above-described process, the LCD 63 continuously displays the images shown in portions (a) to (h) of FIG. 13, whereby an animation indicating that a trapezoidal building diminishes to disappear is displayed.

Obviously, when the input operation reception unit 60 of the operation control apparatus 17 is used to perform a second switching operation (catch operation) for allowing the content display unit 63 to display and play back content that is displayed and played back by the display-playback apparatus 14, 15, or 16 connected to the home network 11, an image displayed by the display-playback apparatus 14, 15, or 16 connected to the home network 11 when the switching operation is performed is gradually enlarged by the animation creator with the VRAM 79 from a reduced state, and the display position is changed from the upper direction to central direction of the LCD 63. While performing the enlargement and the position changing, an animation indicating content movement can be displayed on the content display unit 63.

As described above, in the content display-playback system 10, the operation control apparatus 17 includes the content display unit 63 (FIG. 6) that displays and plays back video and audio of content distributed by streaming from the content providing apparatus 12 or 13 through the home network 11. When, among the display-playback apparatuses 14 to 16 connected to the home network 11, display and playback of content is switched for streaming distribution from the content providing apparatus 12, the content display unit 63 displays an animation indicating content movement.

Therefore, according to the above-described content display-playback system 10, switching of moving images between two image display apparatuses in response to the throw or catch operation can intuitively be shown to a user.

It should be understood by those skilled in the art that various modifications, combinations, sub-combinations and alterations may occur depending on design requirements and other factors insofar as they are within the scope of the appended claims or the equivalents thereof.

What is claimed is:

1. A content display-playback system comprising:
a content providing apparatus connected to a network;
a display-playback apparatus connected to the network; and
an operation control apparatus for controlling operations on the content providing apparatus and the display-playback apparatus,
wherein
content is transmitted and received among the content providing apparatus, the display-playback apparatus, and the operation control apparatus, and each of the display-playback apparatus and the operation control apparatus displays video of the content and plays back audio of the content, the content is distributed by streaming from the content providing apparatus through the network;
the operation control apparatus includes an operation-control-apparatus display-playback unit for displaying video of the distributed content and playing back audio of the distributed content, and
when display and playback of the content distributed by streaming from the content providing apparatus is switched between the operation control apparatus and the display-playback apparatus connected to the network, the operation-control-apparatus display-playback unit displays an animation indicating content movement.

2. A content display-playback method for controlling operations on a content providing apparatus and display-playback apparatus connected to a network by using an operation control apparatus, transmitting and receiving content among the operation control apparatus, the content providing apparatus, and the display-playback apparatus, and displaying video of the content and playing back audio of the content by each of the display-playback apparatus and the operation control apparatus, the content display-playback method comprising the steps of:
between the display-playback apparatus connected to the network and the operation control apparatus, switching display and playback of content distributed by streaming from the content providing apparatus; and
when the display and playback of the distributed content is switched, displaying an animation indicating content movement by a display-playback unit included in the operation control apparatus.

3. The content display-playback method according to claim 2, further comprising the step of, when the display and playback of the distributed content is switched, creating an animation by storing, in a video memory, the video displayed on one of the display-playback unit and the display-playback apparatus connected to the network,
wherein, in the displaying step, the created animation is used to display the animation indicating the content movement.

4. A recording medium having a content display-playback program recorded thereon for controlling operations on a content providing apparatus and display-playback apparatus connected to a network by using an operation control apparatus, transmitting and receiving content among the operation control apparatus, the content providing apparatus, and the display-playback apparatus, and displaying video of the content and playing back audio of the content by each of the display-playback apparatus and the operation control apparatus, the content display-playback program comprising the steps of:
between the display-playback apparatus connected to the network and the operation control apparatus, switching display and playback of content distributed by streaming from the content providing apparatus; and
when the display and playback of the distributed content is switched, displaying an animation indicating content movement by a display-playback unit included in the operation control apparatus.

5. An operation control apparatus for controlling operations on a content providing apparatus and display-playback apparatus connected to a network, transmitting and receiving content among the operation control apparatus, the content providing apparatus, and the display-playback apparatus, and displaying and playing back the content by each of the operation control apparatus and the display-playback apparatus, the operation control apparatus comprising:
an input operation receiving unit for receiving an operation input from a user;
a content-transmission/reception-signal generating unit for generating an operation control signal for transmitting and receiving the content among the operation control apparatus, the content providing apparatus, and the display-playback apparatus in response to the operation input received by the input operation receiving unit; and
a display-playback unit for displaying and playing back desired content in response to a selecting operation control signal and display-playback operation control signal generated by the content-transmission/reception-signal generating unit on the basis of a selecting operation on the desired content and an operation for displaying and playing back the desired content which are received by the input operation receiving unit,
wherein, when display and playback of content distributed by streaming from the content providing apparatus is switched between the operation control apparatus and the display-playback apparatus connected to the network, the display-playback unit displays an animation indicating content movement.

6. The operation control apparatus according to claim 5, further comprising an animation creating unit for creating an animation by storing, in a video memory, video displayed by one of the display-playback unit and the display-playback apparatus connected to the network when the display and playback of the distributed content is switched.

7. The operation control apparatus according to claim 6, wherein, when the input operation receiving unit performs a first switching operation for allowing the display-playback apparatus connected to the network to display and play back the desired content displayed and played back by the display-playback unit, the animation indicating the content movement is displayed on the display-playback unit while the animation creating unit uses the video memory to reduce a size of the video displayed when the display and playback of the distributed content is switched, and upwardly changes a display position of the video.

8. The operation control apparatus according to claim 6, wherein, when the input operation receiving unit performs a second switching operation for allowing the display-playback unit to display and play back the content displayed and played back by the display-playback apparatus connected to the network, the animation indicating the content movement is displayed on the display-playback unit while the animation creating unit uses the video memory to gradually enlarge the video displayed when the display and playback of the distributed content is switched, and changing a display position of the video from upwardly to centrally on the display-playback unit.
